(19) United States
(12) Patent Application Publication
(10) Pub. No.: US 2006/0231988 A1
(43) Pub. Date: Oct. 19, 2006

(54) Multilayer ceramic composite

(76) Inventors: Frank Ehlen, Neunkirchen (DE); Olaf Binkle, Kirkel (DE); Ralph Nonninger, Saarbrucken (DE)

Correspondence Address: Walter A Hackler;Patent Law Offfice, 2372 S E Bristol Street, Suite B, Newport Beach, CA, 92660-0755, US

(21) Appl. No.: 10/543,463

(22) PCT Filed: Nov. 19, 2003
(86) PCT No.: PCT/DE03/03833

§ 371 Date: Apr. 10, 2006

(30) Foreign Application Priority Data
Jan. 30, 2003 (DE) 103 03 897.3

(51) Int. Cl. C04B 33/32; B28B 1/00; C04B 35/64

(52) U.S. Cl. 264/628

(57) ABSTRACT

In a method for producing a porous ceramic compound, a green layer is disposed onto a previously sintered ceramic substrate and is sintered with the previously sintered substrate at temperatures between 500° C. and 1300° C., wherein the green layer comprises exclusively ceramic particles having a particle size of x≦100 nm and the sintered green layer being a functional layer has a layer thickness of s≦2.5 μm. The functional layer produced in this method is flawless and fine-pored and therefore particularly suited for filtration processes.

### PRIOR ART

The invention concerns a method for producing a multi-layer porous ceramic compound through sintering.

Multi-layer porous ceramic compounds can be used e.g. in filter technology and in electronics for forming strip conductor structures. Ceramic multi-layer filters are used e.g. for separating oil-water emulsions in the chip removing production, to clarify beer, for gas purification, gas separation or separation of liquid-solid mixtures. Ceramic filter materials are usually formed from sintered particles with the gaps therebetween forming the pores. For filtering purposes, the portion of pore volume must be as high as possible and the pore size distribution must be as uniform and close as possible. For this reason, ceramic powders with narrow distributed grain size distribution are preferably used for the production of ceramic filter materials.

Ceramic membranes usually consist of a multi-layer system of porous ceramic having individual layers of different pore widths. The actual filtering layer (functional layer) is usually the thinnest layer of the system having the finest pores. It is disposed on a substrate of the system having a structure with larger pores. The substrate simultaneously adopts the mechanical carrier function of the overall system and often also forms structures for collecting filtered matter. The multi-layer filters are produced by initially forming, drying and sintering the substrate, and subsequently applying the functional layer and sintering it onto the substrate. A layer which contains ceramic particles but has not yet been sintered is called a green layer. A body made from this material is correspondingly called green body.

Sintering of a ceramic compound defines a production method during which a green body is transformed into a porous, binder-free solid or into a more or less compacted binder-free solid thereby correspondingly increasing the mechanical solidity or concentration of a previously sintered body. In the idealized case, the initial body for sintering can be regarded as dense package of spherical particles which are loosely connected at contact points, i.e. which contact and adhere to each other at so-called “necks”. The spaces between the particles form the pores of the initial body. The original pores are complicated structures of the most different geometries. Sintering is performed in two stages at an increased temperature. In the first stage, the overall porosity substantially remains. The centers of the particles remain approximately at the same distance from each other. Nevertheless, the surface energy is increased, since the shape of the cavities, i.e. the pores, changes from the complicated structures of the initial state into a simple spherical form, thereby obtaining a minimum surface for a given porosity. The particles contact each other at the “necks” which become thicker in the first sintering stage due to material transport. The pores are thereby rounded to produce a minimum pore surface. This material transport is also called grain boundary diffusion. In the second stage, the pores are gradually closed. The material compacts itself by transporting holes to the inner and outer surfaces (volume diffusion). The overall porosity is reduced through compacting the sinter body. The pores are filled through grain boundary diffusion and volume diffusion. In this step, the centers of the original powder particles move together thereby compacting or shrinking the sinter body.

The extent of an occurring grain boundary diffusion can be detected by the capillary pressure generated in the pores. The shape of the pores is changed through material transport which is initiated by different radii of curvature. The material is transported, in particular, from the “bellies” of the particles to the “necks” of the particles. On average, the bonding of the atoms is stronger on a surface which is curved to the inside (concave) than on a surface which is curved to the outside (convex). The capillary pressure at the “bellies” of the particles is positive, and that at the “necks” of the particles is negative. This pressure difference is the driving force of the material transport. The capillary pressure which initiates sintering of the ceramic green body depends in addition to the temperature and particle type also on the size of the particles used, since the convex curvature radius increases with decreasing particle size. For this reason, the temperature at which sintering of a ceramic green body starts (under the precondition that the packaging density in the green body is the same) drops with decreasing particle size of the initial particles.

In conventional methods wherein a particle layer is disposed onto a sintered substrate followed by re-sintering of the entire ceramic compound, the substrate and the green body are compacted differently due to the above-described processes. This creates stresses between the two material layers which again cause defects in the material layers and/or at the transition regions between the layers. In particular, for filter layers, such defective locations are undesired.

### OBJECT OF THE INVENTION

It is therefore the underlying purpose of the present invention to provide a method for disposing a flawless ceramic layer onto a sintered ceramic substrate.

### SUBJECT MATTER OF THE INVENTION

In accordance with the invention, this object is achieved by a method for producing a multi-layer porous ceramic compound through sintering, wherein one or more layers are disposed onto the surface of a sintered substrate, wherein at least one layer contains nanoscale particles of a particle size of x≦100 nm, the roughness depth of the surface of the substrate is smaller than the layer thickness s of the nanoscale particles disposed onto the surface of the substrate, and the layer thickness s of the disposed nanoscale particles has a layer thickness of s≦2.5 μm after termination of the sintering process with the substrate at temperatures between 500° C. and 1300° C.

The inventive method permits application of a thin, flawless functional layer onto a sintered substrate. While during normal sintering processes, the green body is compacted via grain boundary diffusion and/or volume diffusion, the compacting process can be influenced through selection of a particle size of x≦100 nm and a maximum layer thickness s≦2.5 μm in accordance with the invention in such a manner that floating of grain boundary (grain boundary flow or migration) is initiated, which has not yet been observed in connection with ceramic bodies. The grain boundary flow can prevent stresses between the sintered substrate and the green layer forming the functional layer. The functional layer is thereby sintered up to a thickness of approximately s=2.5 μm and compacted to a greater or lesser degree without causing defects. The inventive method permits production of a faultless functional layer and faultless connection between the functional layer and the substrate which is formed from ceramic particles made from other materials than the functional layer, wherein the latter is not peeled off the substrate during or after sintering. It is possible to achieve excellent filtration results with a functional layer of this type.

The minimum thickness of the functional layer is determined by the roughness depth of the sintered substrate. The roughness depth must not exceed the layer thickness of the functional layer.

The nanoscale particles may have different shapes, e.g. be spherical, plate-shaped or fibrous. The particle size refers in each case to the longest dimension of these particles which would e.g. be the diameter if the particles are spherical.

The ceramic materials used are preferably derived from (mixed) metal oxides and carbides, nitrides, borides, silicides and carbon nitrides of metals and non-metals. Examples thereof are Al₂O₃, partially and completely stabilized ZrO₂, mullite, cordierite, perovskite, spinels, e.g. BaTiO₃, PZT, PLZT and SiC, Si₃N₄, B₄C, BN, MoSi₂, TiB₂, TiN, TiC and Ti(C,N). It is clear that this list is incomplete. It is of course also possible to use mixtures of oxides or non-oxides and mixtures of oxides and non-oxides.

In an advantageous embodiment of the method, two layers are disposed onto the sintered substrate, wherein at least one of the layers contains the nanoscale particles. The filtering properties of the porous ceramic compound can be precisely influenced by providing several layers having different porosities. Particularly good filtration results can be obtained if one of the layers has no defects.

In an alternative method variant, more than two layers are disposed onto the sintered substrate, wherein at least two layers comprise nanoscale particles. A multi-layer porous ceramic compound having good filtering properties is thereby formed.

If the nanoscale particles have a particle size of x≦20 nm, preferably x≦10 nm, a grain boundary flow can be triggered with a low activation energy. This permits use of low sintering temperatures with sintering stresses of approximately 200 MPa.

In an advantageous method variant, the nanoscale particles are disposed onto the sintered substrate through spraying, immersion, flooding or foil casting. If the nanoscale particles are contained in a suspension, disposal thereof onto the sintered substrate is particularly facilitated by the above-mentioned method steps. This measure permits, in particular, good control and adjustment of the layer thickness of the green layer which is disposed onto the sintered substrate, and thereby of the sintered functional layer.

In a particularly preferred manner, an intermediate layer, in particular, an organic intermediate layer is disposed onto the sintered substrate prior to application of the nanoscale particles. An organic binder balances uneven surfaces of the sintered substrate and/or the organic binder prevents infiltration of the nanoparticles forming the functional layer into the surface of the substrate having coarse pores. The organic binder can block and/or smear the pores on the surface of the substrate to prevent inadmissible penetration of the nanoparticles forming the functional layer into the surface of the substrate. In particular, the organic binder may be used to treat the substrate to form a suitable carrier structure. The organic intermediate layer vanishes during sintering, such that the filtering properties of the finished ceramic compound are not influenced by the organic binder.

This object is also achieved by a multi-layer porous ceramic compound comprising a sintered substrate and a flawless functional layer sintered from nanoscale particles and having a layer thickness of s≦2.5 μm. A porous ceramic compound of this type has a filter layer of a particularly high quality, since it has no faults.

In a preferred embodiment, the ceramic compound has three layers, wherein one layer comprises the nanoscale particles. The material properties of the layers can be matched to each other such that at least one filter layer is flawless, thereby producing a high-quality filter.

In an alternative embodiment, the ceramic compound has more than three layers, wherein at least two layers comprise nanoscale particles. With this measure, the filtering effect within the ceramic compound can be gradually increased, wherein at least two layers are provided having particularly fine pores and no defects. It is moreover possible to form multi-layer strip conductor structures, wherein the flawless layer formed from nanoscale particles represents an insulator, which permits to arrange strip conductors at small separations from each other in an electrically insulated manner.

In one method for producing a porous ceramic compound, a green layer is disposed onto a previously sintered ceramic substrate and is sintered with the previously sintered substrate at temperatures between 500° C. and 1300° C., wherein the green layer comprises exclusively ceramic particles having a particle size x≦100 nm and the sintered green layer having a layer thickness s≦2.5 μm. The layer produced with this method is flawless and has fine pores and is therefore particularly suited for filtration processes and may be used as a catalytic converter.

Further features and advantages of the invention can be extracted from the claims. The individual features may be realized individually or collectively in arbitrary combination in a variant of the invention.

1-10. (canceled)

11. Method for producing a multi-layer porous ceramic compound through sintering, by disposing of a flawless ceramic layer onto a sintered ceramic substrate wherein a green layer is disposed directly onto the surface of the sintered substrate, wherein the green layer contains nanoscale particles of a particle size of x≦100 nm and narrowly distributed grain size distribution, and the layer containing the nanoscale particles is disposed in a layer thickness s, which is greater than the roughness depth of the surface of the substrate is disposed onto the substrate and the layer thickness s of the disposed layer containing nanoscale particles has a layer thickness of s≦2.5 μm after sintering with the substrate at temperatures between 500° C. and 1300° C.

12. Method according to claim 11 characterized in that nanoscale particles having a particle size of x≦20 nm, preferably x≦10 nm are used.

13. Method according to claim 11, characterized in that the nanoscale particles are disposed onto the sintered substrate through spraying, immersion, or flooding.

14. Multi-layer porous ceramic compound, produced by a method according to claim 11, which comprises a sintered substrate and a flawless functional layer sintered from nanoscale particles and having a layer thickness of s≦2.5 μm.
